(19) United States
(12) Patent Application Publication
(10) Pub. No.: US 2010/0183811 A1
(43) Pub. Date: Jul. 22, 2010

(54) METHOD FOR ADJUSTING THE NUMBER OF PHASES OF A PTAl-LAYER OF A GAS TURBINE COMPONENT AND METHOD FOR PRODUCING A SINGLE-PHASE PTAl-LAYER ON A GAS TURBINE COMPONENT

(75) Inventor: Heinrich Walter, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero GmbH, Munich (DE)

(21) Appl. No.: 12/602,427

(22) PCT Filed: May 15, 2008
(86) PCT No.: PCT/DE2008/000839

§ 371 Date: Nov. 30, 2009

(30) Foreign Application Priority Data
Jun. 1, 2007 (DE) 102007025697.5

(51) Int. Cl. B05D 3/00

(52) U.S. Cl. 427/331

(57) ABSTRACT

A method for adjusting the number of phases of a PtAl layer of a component of an aircraft engine is disclosed. In an embodiment, the following steps produce a single-phase PtAl layer on the gas turbine component: application of a Pt layer to the gas turbine component, the thickness thereof being less than 4 μm; homogenization such that the Pt in the base material of the gas turbine component is diffused; and aluminization and control such that an Al content that is less than or equal to 23% by weight is adjusted; and the following steps produce a two-phase PtAl layer: application of a Pt layer to the gas turbine component, the thickness thereof being in the range of 5 μm to 8 μm; homogenization such that the Pt in the base material of the gas turbine component is diffused; and aluminization in order to produce the PtAl layer.

### BACKGROUND AND SUMMARY OF THE INVENTION

This application claims the priority of International Application No. PCT/DE2008/000839, filed May 15, 2008, and German Patent Document No. 10 2007 025 697.5, filed Jun. 1, 2007, the disclosures of which are expressly incorporated by reference herein.

The invention relates to a method for adjusting the number of phases of a PtAl layer of a gas turbine component, in particular a component of an aircraft engine, as well as a method for producing a single-phase PtAl layer on a gas turbine component.

Single-phase PtAl layers are already known just like two-phase PtAl layers. For single-phase PtAl layers, most of the time homogenization is required after aluminization in order to lower the Al and Pt concentrations enough that a single-phase structure emerges. This structure has advantages with respect to its mechanical properties. With this as the background, the objective of the invention is creating a possibility for producing a single-phase PtAl layer in a simple and cost-effective manner. Furthermore, it would be particularly desirable if a possibility could be produced for influencing or adjusting the phase-ness of a PtAl layer.

### DETAILED DESCRIPTION OF THE INVENTION

Thus, in particular a method for influencing, in particular adjusting, the number of phases of a PtAl layer of a gas turbine component, in particular of a component of an aircraft engine, is provided, which is carried out or supposed to be carried out in particular when producing the type of layer during the course of the production or reconditioning of the type of gas turbine raw part. In this case, it is provided that steps assigned to a first group are carried out to produce a single-phase PtAl layer on the gas turbine component, and steps assigned to a second group are carried out to produce a two-phase PtAl layer on a gas turbine component. The steps in the first group include the following steps: application of a Pt layer to the gas turbine component, the thickness thereof being less than 4 μm; homogenization such that the platinum (Pt) in the base material of the gas turbine component is diffused; and aluminization and control such that an aluminum content (Al content) that is less than or equal to 23% by weight is adjusted, preferably less than or equal to 22% by weight, preferably less than or equal to 20% by weight, preferably less than or equal to 18% by weight, preferably less than or equal to 15% by weight, preferably less than or equal to 13% by weight, preferably less than or equal to 10% by weight.

The following steps are part of the second group: application of a platinum layer (Pt layer) to the gas turbine component, the thickness thereof being in the range of 5 μm to 8 μm, preferably in the range of 5 μm to 6 μm; homogenization such that the platinum in the base material of the gas turbine component is diffused; and aluminization in order to produce the PtAl layer.

The aluminization to produce a two-phase PtAl layer on the gas turbine component is carried out in a preferred embodiment over a period of time that lies in the range of 8 to 15 hours, preferably in the range of 11 to 13 hours.

Furthermore, a method for producing a single-phase PtAl layer on a gas turbine component, in particular for a component of an aircraft engine, is provided. This method is carried out in particular during the course of the production or reconditioning of the type of gas turbine components. The method features the following steps: application of a Pt layer to the gas turbine component, the thickness thereof being less than 4 μm; homogenization such that the platinum in the base material of the gas turbine component is diffused; and aluminization to produce the PtAl layer and control such that an Al content that is less than or equal to 23% by weight is adjusted, preferably less than or equal to 22% by weight, preferably less than or equal to 20% by weight, preferably less than or equal to 18% by weight, preferably less than or equal to 15% by weight, preferably less than or equal to 13% by weight, preferably less than or equal to 10% by weight.

An advantageous further development provides that the platinum layer, which is applied to this gas turbine component to produce a single-phase PtAl layer on the gas turbine component, is applied with a thickness that is in the range of 1 to 2 μm.

An advantageous embodiment provides that the homogenization, which is carried out to produce a single-phase PtAl layer on the gas turbine component, in order to cause the platinum in the base material of the gas turbine component to diffuse, is carried out over a period of time that lies in the range of 0.2 to 4 hours, preferably in the range of 0.5 to 2 hours.

A particularly preferred further development provides for the aluminization to produce a single-phase PtAl layer on the gas turbine component to be carried out of over a period of time that lies in the range of 3 to 11 hours, in particular in the range of 6 to 10 hours.

It is thus especially preferred that a very thin Pt layer, approx. 1 to 2 μm thick, be applied.

The base material of the gas turbine component may be a nickel-based alloy or a cobalt-based alloy for example.

The aluminization for producing the single-phase and/or two-phase PtAl for example may be carried out by CVD, e.g., in a gas phase or in a pack cementation process.

It should be noted that the Pt layer can be applied for example by electroplating or by sputtering.

In particular it can also be provided that the application of the Pt layer is carried out by PVD or by CVD.

In particular it is provided that the Pt layer then be homogenized as usual. This homogenization may be of a relatively short duration (e.g., 0.5 to 2 hours). Afterwards, aluminization is applied in an advantageous embodiment. This aluminization can be controlled such that it yields a low aluminum content such as, for example, an aluminum content of less than 20% or of less than 20% by weight or of less than 22% or of less than 22% by weight. This means in particular that the donor and the activator are adjusted correspondingly.

The invention makes possible, at least in the advantageous further development, production with low manufacturing costs, because the customary platinum layer thickness of 4 to 6 μm can be reduced to approx. 1 to 2 μm, because it is possible to dispense with a homogenization that is to be carried out after the aluminization, something that applies in particular for single-phase PtAl layer.

1.-7. (canceled)

8. A method for adjusting a number of phases of a PtAl layer of a gas turbine component when producing the layer during a course of production or reconditioning of the gas turbine component:
comprising the steps of:
application of a Pt layer to the gas turbine component, a thickness of the Pt layer being less than 4 μm;
homogenization such that Pt in a base material of the gas turbine component is diffused; and
aluminization and control after the homogenization such that an Al content that is less than or equal to 23% by weight is adjusted;
to produce a single-phase PtAl layer on the gas turbine component;
and comprising the steps of:
application of a Pt layer to the gas turbine component, a thickness of the Pt layer being in a range of 5 μm to 8 μm;
homogenization such that Pt in a base material of the gas turbine component is diffused; and
aluminization after the homogenization in order to produce the PtAl layer;
to produce a two-phase PtAl layer on the gas turbine component.

9. The method according to claim 8, wherein to produce the two-phase PtAl layer on the gas turbine component the thickness of the Pt layer is in a range of 5 μm to 6 μm.

10. The method according to claim 8, wherein to produce the two-phase PtAl layer on the gas turbine component the aluminization is carried out of over a period of time that lies in the range of 8 to 15 hours.

11. A method for producing a single-phase PtAl layer on a gas turbine component during a course of production or reconditioning of the gas turbine component, comprising the steps of:
application of a Pt layer to the gas turbine component, a thickness of the Pt layer being less than 4 μm;
homogenization such that Pt in a base material of the gas turbine component is diffused; and
aluminization after the homogenization to produce the PtAl layer and control such that an Al content that is less than or equal to 23% by weight is adjusted.

12. The method according to claim 8, wherein to produce the single-phase PtAl layer on the gas turbine component the Pt layer is applied with a thickness that is in the range of 1 μm to 2 μm.

13. The method according to claim 8, wherein to produce the single-phase PtAl layer on the gas turbine component the homogenization is carried out over a period of time that lies in the range of 0.2 to 4 hours.

14. The method according to claim 8, wherein to produce the single-phase PtAl layer on the gas turbine component the aluminization is carried out of over a period of time that lies in the range of 3 to 11 hours.

15. The method according to claim 8, wherein the gas turbine component is a component of an aircraft engine.

16. The method according to claim 11, wherein to produce the single-phase PtAl layer on the gas turbine component the Pt layer is applied with a thickness that is in the range of 1 μm to 2 μm.

17. The method according to claim 11, wherein to produce the single-phase PtAl layer on the gas turbine component the homogenization is carried out over a period of time that lies in the range of 0.2 to 4 hours.

18. The method according to claim 11, wherein to produce the single-phase PtAl layer on the gas turbine component the aluminization is carried out of over a period of time that lies in the range of 3 to 11 hours.

19. The method according to claim 11, wherein the gas turbine component is a component of an aircraft engine.
